(19) United States
(12) Patent Application Publication
(10) Pub. No.: US 2026/0158968 A1
(43) Pub. Date: Jun. 11, 2026

(54) METHOD AND DEVICE FOR ADJUSTING BATTERY STATE OF CHARGE (SOC) REQUIREMENTS IN A FUEL CELL VEHICLE USING ROADWAY INFORMATION

(71) Applicants: HYUNDAI MOTOR COMPANY, Seoul (KR); KIA CORPORATION, Seoul (KR)

(72) Inventors: Sang Pil Jang, Hwaseong-si (KR); Ha Won Sung, Hwaseong-si (KR)

(73) Assignees: HYUNDAI MOTOR COMPANY, Seoul (KR); KIA CORPORATION, Seoul (KR)

(21) Appl. No.: 19/182,145

(22) Filed: Apr. 17, 2025

(30) Foreign Application Priority Data
Sep. 24, 2024 (KR) 10-2024-0128896

(51) Int. Cl. B60L 58/40; B60L 58/12; B60L 58/30

(52) U.S. Cl. CPC B60L 58/40; B60L 58/12; B60L 58/30; B60L 2240/642

(57) ABSTRACT

A method for correcting a battery state of charge (SOC) of a vehicle includes dividing a roadway segment of a roadway in front of the vehicle into at least two or more segments; obtaining roadway information for each segment of the at least two or more segments of the roadway, determining an expected battery SOC demand value of each segment based on the obtained roadway information, determining whether to correct the expected battery SOC demand value of the each segment based on whether the at least two or more segments have continuous gradients, and based thereon, performing correction of the expected battery SOC demand value.

### CROSS REFERENCE TO RELATED APPLICATION

The present application claims the benefit of priority to Korean provisional application 10-2024-0128896, filed on Sep. 24, 2024, the entire disclosure of which is incorporated herein for all purposes by this reference.

### BACKGROUND

### Technical Field

The present disclosure relates to a method and device for correcting or adjusting a battery state of charge (SOC) requirements in a fuel cell vehicle by using forward driving (i.e., roadway) information. More particularly, the present disclosure relates to a method and device for correcting a battery SOC demand value to prevent a battery SOC demand prediction error based on roadway information obtained from a peripheral device based on each segment of the roadway in front of the vehicle.

### Discussion of the Related Art

Generally, a vehicle (or ‘moving object’) is controlled based on the current state of the vehicle and the actions of the driver. In a conventional fuel cell power generation control method for a commercial fuel cell electric vehicle (FCEV), a fuel cell (FC) power map for an SOC of a high-voltage battery may be determined usually by calculating a vehicle output power demand based on the force a driver applies to the acceleration pedal and a service output power of vehicle accessories.

Specifically, a conventional commercial FCEV controls fuel cell power generation by calculating a vehicle output power demand based on the force a driver applies to the acceleration pedal, the service output power of vehicle accessories, and by determining an FC power map according to the SOC of a high-voltage battery. In this case, even when the roadway to be driven on is a long uphill segment or a long downhill segment, as power is generated by the FC power map in a current driving segment, there is a problem in that a battery SOC necessary for future driving segments is not sufficiently secured. In other words, the necessary battery SOC may not be obtained, or sufficient enough, to provide the required amount of energy/charge for the vehicle to operate efficiently when being driven via the segments of the roadway in front of the vehicle to reach a destination.

### SUMMARY

The present disclosure is technically directed to providing a method and device for correcting or adjusting a battery SOC of a vehicle by predicting a battery SOC value with minimum error based on information on a roadway ahead of the vehicle obtained from a peripheral device of the vehicle.

Further, to solve the technical problems of the present disclosure, the present disclosure is directed to providing a correction device and method for dividing a roadway, on which a vehicle is driven, into segments and calculating a corrected battery SOC demand value according to each of the segments.

The present disclosure solves a technical problem of current systems that predict a battery SOC demand value without dividing the roadway into at least two or more segments, and thus a prediction error of the battery SOC demand value may occur. In other words, in current FCEVs, a battery SOC value, which may be secured or obtained in a previous driving segment beforehand may not correspond to a battery SOC value that is required when a forward driving segment becomes the current driving segment.

Thus, the disclosed embodiments provide a method and a device for correcting a prediction of a battery SOC demand value of a vehicle. The disclosed embodiments provide a solution beyond merely calculating a battery SOC value. Instead, the disclosed embodiments divide the roadway in front of the vehicle by at least two segments and use roadway information obtained from the peripheral device(s) of the vehicle to calculate an expected SOC demand value of each segment to determine whether to correct an expected battery SOC demand value of each segment.

The technical problems solved by the present disclosure are not limited to the above technical problems and other technical problems which are not described herein should be clearly understood by a person having ordinary skill in the art, to which the present disclosure belongs, from the following description.

According to the present disclosure, a method is provided for correcting a battery SOC of a vehicle. The method may include dividing a roadway segment of a roadway in front of the vehicle into at least two or more segments, obtaining roadway information for each segment of the at least two or more segments of the roadway, determining or calculating an expected battery SOC demand value of each segment based on the obtained roadway information, determining whether to correct the expected battery SOC demand value of the each segment based on whether the at least two or more segments have continuous gradients, and performing a correction of the expected battery SOC demand value.

According to an embodiment of the present disclosure, the at least two or more segments include a current driving segment and a forward driving segment. Determining the expected battery SOC demand value includes dividing the forward driving segment into a first forward driving segment and a second forward driving segment. The method further includes calculating the expected battery SOC demand value of each segment based on the obtained roadway information.

According to an embodiment of the present disclosure, the method further includes determining the expected SOC demand value by multiplying an expected battery charge/discharge output value and an expected future driving time. The method further includes determining a required battery SOC demand value by dividing the expected battery SOC demand value by a total battery energy value.

According to an embodiment of the present disclosure, the method further includes determining whether the first forward driving segment and the second forward driving segment have continuous gradients based on whether the required battery SOC demand value has a same sign.

According to an embodiment of the present disclosure, the method further includes, comparing, based on the first forward driving segment and the second forward driving segment having continuous gradients at entry into the first forward driving segment, a battery SOC demand value secured in an immediate previous driving segment with the expected battery SOC demand value of the first forward driving segment.

According to an embodiment of the present disclosure, the method further includes, determining, based on a battery SOC demand value secured at entry into the current driving segment being greater than the expected battery SOC demand value of the immediate previous driving segment, a corrected battery SOC demand value by subtracting a battery margin secured in the immediate previous driving segment from the battery SOC demand value of the first forward driving segment.

According to an embodiment of the present disclosure, the method further comprises determining a total battery charge/discharge SOC value for fuel cell power generation control by adding the expected battery SOC demand value of the first forward driving segment and the expected battery SOC demand value of the second forward driving segment.

According to an embodiment of the present disclosure, the method further includes determining, based on the first forward driving segment and the second forward driving segment being long uphills, that the expected battery SOC demand value is an expected battery discharge output value. The method further includes calculating the expected battery discharge output value by multiplying a battery efficiency value and a value obtained by subtracting an expected fuel cell power generation value from an expected gradient driving output value during driving.

According to an embodiment of the present disclosure, the method further includes determining, based on the first forward driving segment and the second forward driving segment being long downhills, that the expected battery SOC demand value is an expected battery charge output value. The method further includes obtaining the expected battery charge output value by dividing an expected gradient driving output value by a battery efficiency value.

According to an embodiment of the present disclosure, the method further includes preventing, based on the first forward driving segment and the second forward driving segment having no continuous gradients, performing correction of the expected battery SOC demand value.

According to another embodiment of the present disclosure, a device is provided for correcting a battery SOC of a vehicle. The device includes a memory configured to store at least one instruction. The device further includes a processor configured to execute the at least one instruction stored in the memory, and divide a roadway segment of a roadway in front of the vehicle into at least two or more segments. The device includes a peripheral device configured to obtain roadway information for each segment of the at least two or more segments of the roadway. The processor is further configured to determine or calculate an expected battery SOC demand value based on the roadway information of each segment that is input from the peripheral device, determine whether to correct the expected battery SOC demand value based on whether the at least two or more segments have continuous gradients, and, based thereon, perform correction of the expected battery SOC demand value.

According to an embodiment of the present disclosure, the at least two segments include a current driving segment and a forward driving segment. The processor, to determine the expected battery SOC demand value, is configured to divide the forward driving segment into a first forward driving segment and a second forward driving segment. The processor is further configured to calculate the expected battery SOC demand value based on the obtained roadway information.

According to an embodiment of the present disclosure, the processor is further configured to determine the expected SOC demand value by multiplying an expected battery charge/discharge output value and an expected future driving time. The processor is further configured to determine a required battery SOC demand value by dividing the expected battery SOC demand value by a total battery energy value.

According to an embodiment of the present disclosure, the processor is further configured to determine whether the first forward driving segment and the second forward driving segment have continuous gradients based on whether the required battery SOC demand value (of each segment) has a same sign.

According to an embodiment of the present disclosure, the processor is further configured to compare, based on the first forward driving segment and the second forward driving segment having continuous gradients, at entry into the first forward driving segment, a battery SOC demand value secured in an immediate previous driving segment with the expected battery SOC demand value of the first forward driving segment.

According to an embodiment of the present disclosure, the processor is further configured to determine, based on the battery SOC demand value secured at entry into the current driving segment being greater than the expected battery SOC demand value of the immediate previous driving segment, a corrected battery SOC demand value by subtracting a battery margin secured in the immediate previous driving segment from the battery SOC demand value of the first forward driving segment.

According to an embodiment of the present disclosure, the processor is further configured to determine a total battery charge/discharge SOC value for fuel cell power generation control by adding the expected battery SOC demand value of the first forward driving segment and the expected battery SOC demand value of the second forward driving segment.

According to an embodiment of the present disclosure, the processor is further configured to determine, based on the first forward driving segment and the second forward driving segment being long uphills, that the expected battery SOC demand value is an expected battery discharge output value. The processor is further configured to calculate the expected battery discharge output value by multiplying a battery efficiency value and a value obtained by subtracting an expected fuel cell power generation value from an expected gradient driving output value during driving.

According to an embodiment of the present disclosure, the processor is further configured to determine, based on the first forward driving segment and the second forward driving segment being long downhills, that the expected battery SOC demand value is an expected battery charge output value. The processor is further configured to obtain the expected battery charge output value by dividing an expected gradient driving output value by a battery efficiency value.

According to an embodiment of the present disclosure, the processor is further configured to prevent, based on the first forward driving segment and the second forward driving segment having no continuous gradients, correction of the expected battery SOC demand value.

The effects obtainable from the present disclosure are not limited to the above-mentioned effects. Other effects not mentioned herein should be clearly understood by those of ordinary skill in the art through the following description.

### BRIEF DESCRIPTION OF THE DRAWINGS

FIG. 1 shows a block diagram illustrating constituent modules of a vehicle equipped with a battery SOC correction device according to an embodiment of the present disclosure.

FIGS. 2A and 2B show flowcharts of a method for correcting a battery SOC of a vehicle according to another embodiment of the present disclosure.

FIG. 3 shows a block diagram showing a passenger vehicle power map according to an embodiment of the present disclosure.

FIGS. 4A and 4B show a predictive battery SOC control process for a commercial FC vehicle according to a current driving segment and at least two or more driving segments for fuel cell power generation control according to another embodiment of the present disclosure.

FIG. 5 shows an estimation result of change in a corrected battery SOC demand value according to each segment of a roadway with continuous gradients.

FIG. 6 shows a flowchart of an operating mechanism of a battery SOC correction device according to another embodiment of the present disclosure.

### DETAILED DESCRIPTION

Hereinafter, embodiments of the present disclosure are described in detail with reference to the accompanying drawings to enable those having ordinary skill in the art to readily implement the embodiments of the present disclosure. However, embodiments of the present disclosure may be implemented in various different ways. The present disclosure is not limited to the embodiments described therein.

In describing embodiments of the present disclosure, well-known features, functions, or constructions have not been described in detail where it is determined that a detailed description thereof may unnecessarily obscure the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise. When a component, device, element, or the like of the present disclosure is described as having a purpose or performing an operation, function, or the like, the component, device, or element should be considered herein as being “configured to” meet that purpose or perform that operation or function.

In the present disclosure, the terms first, second, and the like, are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements that are distinguished from each other are distinguished merely for clearly describing each feature. This distinction does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to embodiments of the present disclosure described below in detail in conjunction with the accompanying drawings. The embodiments of the present disclosure, however, may be embodied in many different forms and should not be constructed as being limited to the embodiments set forth herein. Rather, the embodiments described herein are provided to fully convey the scope of the present disclosure to those having ordinary skill in the art to which the present disclosure pertains.

Throughout the present disclosure terms such as “electrical devices” refer to those related to battery charging and discharging in the vehicle, including a drive motor and a starter generator (HSG) that can charge the battery by converting the braking and inertial energy of the vehicle into electrical energy during regenerative braking or other driving conditions. Further, the term “sign” refers to the property of a value or a number, e.g., a battery SOC demand value, being positive (+), negative (−), or zero.

The disclosed method may minimize driving issues caused by smart power control by limiting the target battery's SOC (State of Charge) change or adjusting the charging/discharging rate weight based on the reliability of the vehicle's driving path. The reliability of the driving path refers to the trustworthiness of the gradient information of the current driving path received by the smart power control logic. Even if the driving path changes, the reliability is considered high when the gradient information remains similar. For example, when transitioning from one uphill to another uphill path, the reliability is considered to be high. However, if the gradient information is likely to reverse due to a path change, such as transitioning from uphill to downhill, the reliability is considered low.

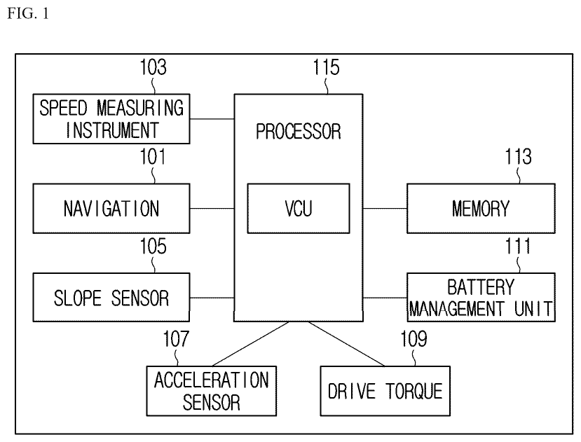

Referring to FIG. 1, a fuel cell power generation control device of a vehicle is described according to an embodiment of the present disclosure.

FIG. 1 is a block diagram illustrating constituent modules of a vehicle equipped with a battery SOC correction device according to an embodiment of the present disclosure.

In one embodiment, the battery SOC correction device may be mounted in a commercial hydrogen electric vehicle such as a large hydrogen electric truck. In other embodiments, the battery SOC correction device may be mounted in other types of vehicles. The battery SOC correction device may receive road gradient information of a destination point located at a predetermined distance or more away from a vehicle on a roadway in front of the vehicle. The battery SOC correction device may divide the roadway delimited by the predetermined distance to the destination point (i.e., the roadway or roadway segment between the vehicle and the destination point) into two or more segments, calculate a battery SOC demand value for each segment of the roadway, and perform power control and battery SOC correction of the vehicle.

The battery SOC correction device may include a peripheral device, or devices, which may include one or more devices or sensors to obtain roadway information around or ahead of the vehicle. The one or more devices or sensors may include a navigation unit 101, a speed measuring instrument 103, a slope sensor 105, an acceleration sensor 107 and a drive torque sensor 109. The peripheral device may also include a battery management unit 111 and a memory 113. The peripheral device may further include various devices other than the constituent elements illustrated in FIG. 1. In this regard, in some embodiments, a connected car Navigation Cockpit (ccNc) hardware and application developed by the applicant may be provided in the vehicle. The ccNc may perform a function of obtaining the roadway information. Accordingly, the roadway information according to the present disclosure may be obtained from the ccNc.

The navigation unit 101 may send out roadway information including road information and/or repeated driving route information. Road information may include a vehicle speed limit of a roadway ahead on which the vehicle is being driven. Repeated driving route information may be a route registered by a user or an automatically registered route based on repeated roadway driving over a predetermined number of times.

Apart from the navigation unit 101, the peripheral device of the battery SOC correction device of the vehicle may comprise sensors to measure and obtain roadway information including but not limited to information related to the vehicle and segments of the roadway ahead of the vehicle. As mentioned above, the sensors may include the speed measuring instrument 103, the slope sensor 105, the acceleration sensor 107, and the drive torque sensor 109. The speed measuring instrument 103 may measure a driving speed of the vehicle. The acceleration sensor 107 may measure a driving direction of the vehicle and the acceleration in a different direction from the driving direction. In addition, a weight of the vehicle may be calculated via the acceleration sensor 107 and the drive torque sensor 109.

The battery management unit 111 may play a role to enhance energy efficiency by optimally managing a state of charge (SOC) of a vehicle battery. Such a battery management unit 111 may be implemented as a battery management system (BMS). The battery management unit 111 may monitor the voltage, current and/or temperature of the vehicle battery in real time by using the sensors of the peripheral device. The battery management unit 111 may prevent overcharge and over discharge of the vehicle battery via the monitoring. In addition, the battery management unit 111 may calculate an SOC of a vehicle battery (battery SOC) by current and/or voltage measured by the sensors. A vehicle battery may supply a power source to an electrical device mounted in a vehicle such as an electronic control unit (ECU) and/or a drive motor.

The battery SOC correction device may include a non-transitory memory 113 specifically configured to store an application and various types of data for controlling a vehicle and at a request of a processor, load the application or read and record data. The memory 113 may include a non-volatile memory and a volatile memory.

The battery SOC correction device may include a processor 115 coupled with the memory 113 and specifically configured to perform overall control of the vehicle. The memory 113 is configured to store computer-executable instructions that cause the processor 115 to perform/execute methods and functions according to the various embodiments of the present disclosure. In particular, the operations of the devices and sensors shown in FIG. 1 may be controlled by the computer-executable instructions stored in the memory 113 and executed by the processor 115.

The processor 115 may have at least one processing module, and each control-related function may be implemented in a single processing module or may be implemented in a corresponding processing module among a plurality of modules. In relation to the present disclosure, the processor 115 may control the moving object, i.e., the vehicle, to correct a battery SOC by using an application, an instruction, and/or data stored in the memory 113. A person having ordinary skill in the art should appreciate that one or more modules described herein may be implemented using, among other things, a tangible computer-readable medium, e.g., the memory 113, comprising computer-executable instructions (e.g., executable software code). Alternatively, modules may be implemented as software code, firmware code, specifically configured hardware or processors, and/or a combination of the aforementioned.

Specifically, the processor 115 may obtain at least one of a driving distance of each segment of a roadway, a speed limit, and whether there is a gradient as roadway information during driving of the vehicle and then calculate an expected battery SOC demand value based on the obtained roadway information. In addition, the processor may exclude a battery charge/discharge output SOC demand value in a current driving segment in order to prevent a prediction error in the expected battery SOC demand value based on the expected battery SOC demand value.

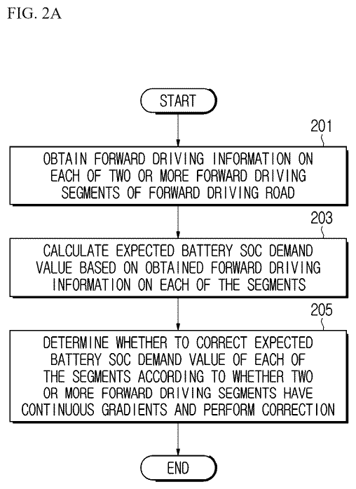

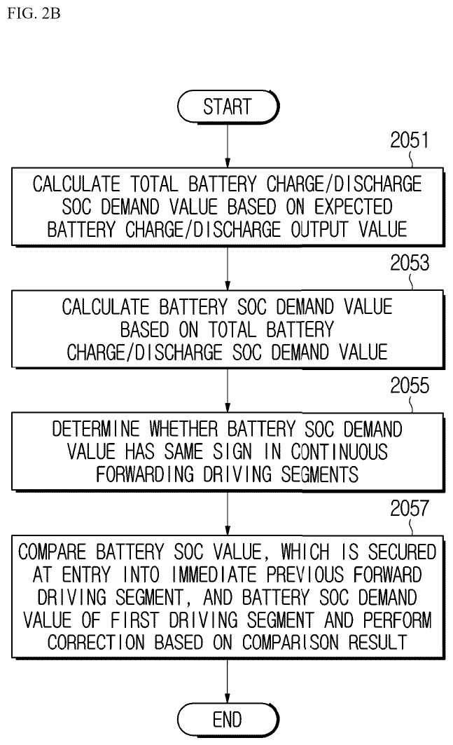

The battery SOC correction device of the vehicle, according to the present disclosure, may be configured to implement processing of correction of a battery SOC demand value via a processor by including at least the speed measuring instrument 103, the navigation unit 101, the slope sensor 105, the acceleration sensor 107, the drive torque sensor 109, the memory 113, the battery management unit 111 and the processor 115. The processing may be implemented by at least a portion of the processor such as at least one processing module, and the memory 113 may function as a vehicle control unit (VCU). The above-described processing of the processor is described in detail in reference to FIGS. 2A and 2B.

FIGS. 2A and 2B are flowcharts of a method for correcting a battery SOC of a vehicle according to another embodiment of the present disclosure.

Referring to FIG. 2A, a method for correcting a battery SOC of a vehicle according to the present disclosure may include obtaining roadway information on each segment of two or more segments of a roadway in front of the vehicle (201), determining or calculating an expected battery SOC demand value based on the obtained roadway information (203), determining whether to correct the expected battery SOC demand value of each segment based on whether the two or more segments have continuous gradients and performing a correction of the expected battery SOC demand value (205).

According to step 201, the obtaining of the roadway information on each of the two or more segments of the roadway is performed by one or more peripheral devices of the vehicle.

For example, a peripheral device may include a navigation unit that may provide information on a vehicle speed limit according to each segment of the roadway and the driving distance of the vehicle. The peripheral device may include a speed measuring instrument that may provide a current speed of the vehicle. The peripheral device may include a slope sensor that may provide information indicative of gradient data about the angle between each segment of the roadway and determine whether the roadway ahead has a gradient based on the collected data for each segment. The peripheral device may include an acceleration sensor and a drive torque sensor that may provide information necessary to calculate the weight of the vehicle.

According to step 203, determining or calculating the expected battery SOC demand value based on the obtained roadway information on each segment of the two or more segments of the roadway may include determining or calculating the expected battery SOC demand value based on at least a forward driving segment that is divided into a first forward driving segment, a second forward driving segment, or more segments that are detected or determined based on information obtained through the peripheral devices of the vehicle. The forward driving segment refers to a segment of the roadway ahead or in front of the vehicle.

The expected battery SOC demand value is an expected battery discharge output value when a first forward driving segment and a second forward driving segment of the segments, which are detected by the slope sensor, are determined to be long uphills or uphill segments (i.e., ascending roads or ascending segments having a longer distance than a threshold distance). In this case, the expected battery discharge output value may be obtained by subtracting an expected fuel cell power generation output value from an expected gradient driving output value, when the vehicle is being driven.

On the other hand, when the first forward driving segment and the second forward driving segment of the roadway detected by the slope sensor are determined to be long downhills or downhill segments (i.e., descending roads or descending segments having a longer distance than a threshold distance), the expected battery output value is an expected battery charge output value. Herein, the expected battery charge output value may be an expected gradient driving output value during regenerative braking.

According to step 205, determining whether to correct the expected battery SOC demand value of the each of the segments based on whether the two or more forward driving segments have continuous gradients and performing the correction of the expected battery SOC demand value may be performed via the steps shown in FIG. 2B.

Referring to FIG. 2B, step 205 of FIG. 2A may include calculating a total battery charge/discharge SOC demand value based on the expected battery charge/discharge output value (2051), calculating a battery SOC demand value based on the total battery charge/discharge SOC demand value (2053), determining whether the battery SOC demand value has a same sign (i.e., positive or negative value) in continuous forwarding driving segments (2055), and comparing a battery SOC value, which is secured at entry into an immediate previous driving segment, and a battery SOC demand value of an immediate previous driving segment (2057).

According to FIG. 2B, step 205 of FIG. 2A includes calculating, according to step 2051, the total battery charge/discharge SOC demand value based on the expected battery charge/discharge output value at step 2051. The total battery charge/discharge SOC demand value may be determined by multiplying the expected battery charge/discharge output value and an expected future driving time of the vehicle.

In addition, the expected battery output value may be obtained by a VCU via a vehicle dynamics equation. In one embodiment, a vehicle dynamics equation may be represented by Equation 1 below.

$$\begin{matrix}{F}_{trction} = ( {F}_{drag} + {F}_{roll} + {F}_{grade} ) \\ = 0.5 * ρ * {C}_{d} * A * {V}^{2} + mg * ( {C}_{r} cos θ + sin θ )\end{matrix} \qquad [ Equation 1 ]$$

In Equation 1 shown above, F_{traction} is a traction force, F_{drag} is air drag, Fᵣₒₗₗ is rolling resistance, and F_{grade} is gradability. The variable m is a vehicle weight, g is the acceleration of gravity, p is air density, C_{d} is an air resistance coefficient, A is a front area, and Cᵣ is a rolling resistance coefficient.

According to step 2053, calculating the battery SOC demand value based on the total battery charge/discharge SOC demand value may include dividing the total battery charge/discharge SOC demand value for two or more forward driving segments by an expected future driving time of the vehicle. Herein, the expected future driving time of the vehicle may be a value obtained by dividing a current segment distance by a vehicle speed.

According to step 2055, determining whether the battery SOC demand value has a same sign in the continuous first and second forward driving segments may determine whether the forward driving segments are continuous uphills or continuous downhills by determining whether a battery SOC demand value calculated from each of the forward driving segments at step 2053 has a same sign. In this case, if the battery SOC demand value of each of the forward driving segments does not have the same sign, an uncorrected value may be determined as a corrected battery SOC demand value of the first forward driving segment.

Next, the comparing of the battery SOC value, which is secured at entry into an immediate previous driving segment, and the battery SOC demand value of an immediate previous first forward driving segment according to step 2057 and the performing of the correction according to a comparison result may be performed when the forward driving segments are determined as continuous uphills or continuous downhills, i.e., as continuous gradients.

In this case, it may be determined whether the battery SOC value, which is secured when the vehicle enters the immediate previous driving segment, is greater than the battery SOC demand value of the first forward driving segment. If the battery SOC value secured at the entry into the immediate previous driving segment is greater, a value obtained by subtracting a battery SOC margin value, which is already secured from the immediate previous driving segment, from a battery SOC demand value of the second forward driving segment may be determined as a corrected battery SOC demand value. Herein, the battery SOC margin value, which is already secured from the immediate previous driving segment, may be obtained by subtracting the battery SOC demand value of the first forward driving segment from the battery SOC value secured at the entry into the immediate previous driving segment.

On the other hand, if the battery SOC demand value of the first forward driving segment is greater than the battery SOC value secured at the entry into the immediate previous driving segment, the battery SOC demand value may not be corrected.

In order to prevent a prediction error in a battery SOC demand value in smart power control, a total battery charge/discharge SOC demand value for smart power control may be determined by adding a corrected battery SOC demand value of the first forward driving segment, which is calculated via step 2057, and a corrected battery SOC demand value of the second forward driving segment. For the determined total battery charge/discharge SOC demand value, the battery SOC correction device of the vehicle enables performing a smart power control capable of securing an expected battery SOC value necessary for a forward driving segment in advance.

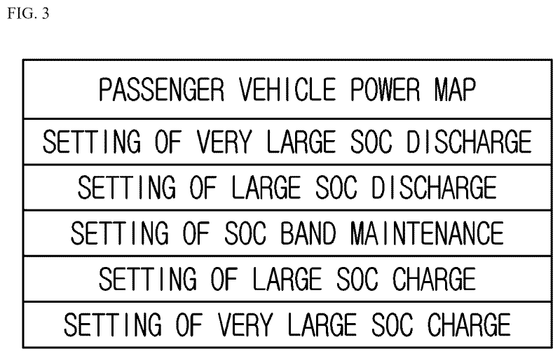

FIG. 3 is a block diagram showing a passenger vehicle power map according to another embodiment of the present disclosure.

Referring to FIG. 3, the passenger vehicle power map may consist of a plurality of grades according to a necessary battery SOC charge or discharge degree. A battery SOC value may be output by selecting any one value of the plurality of grades. For example, the plurality of grades may include a setting of a very large SOC discharge, a setting of a large SOC discharge, a setting of SOC band maintenance, a setting of a large SOC charge, and a setting of a very large SOC charge. However, this is merely one example, and a passenger vehicle power map according to the present disclosure may be divided into a plurality of grades equal to or greater than 5 grades (e.g., 10 grades, 12 grades, and the like).

A corrected SOC value, which is input into the passenger vehicle power map, may be calculated from an actual battery SOC value, which is received from a battery management system (BMS) of a battery management unit, and an SOC value to be surplus or deficit. The battery BMS may be a rechargeable battery system such as a Lithium-ion battery.

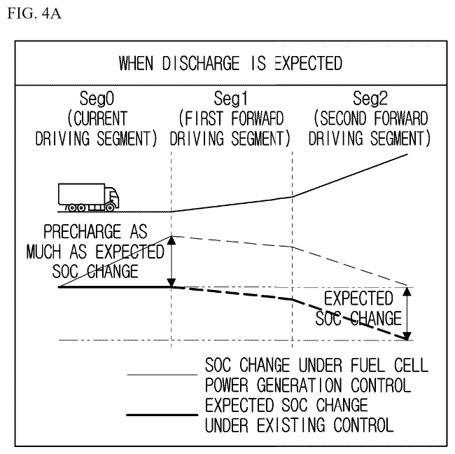

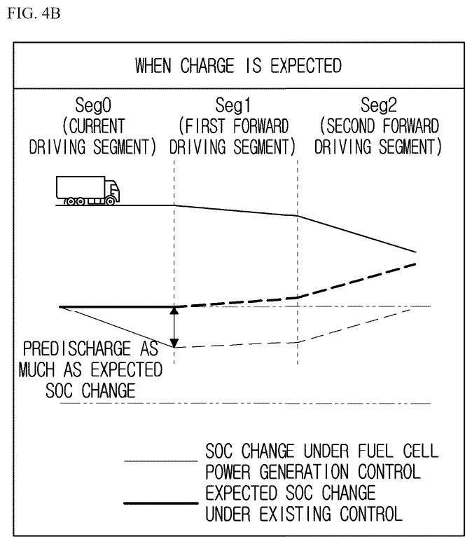

FIGS. 4A and 4B are views showing a predictive battery SOC control process for a vehicle, e.g., a commercial FC vehicle, based on a current driving segment and each of at least two or more forward driving segments for fuel cell power generation control according to another embodiment of the present disclosure.

Referring to FIGS. 4A and 4B, a battery SOC correction method according to the present disclosure may calculate an expected amount of battery SOC change based on whether each segment of the roadway ahead of the vehicle has a gradient and a degree of gradient, convert the amount into a required battery charge/discharge output in the current driving segment, and thus control a fuel cell power generation output. Thus, it is possible to secure or obtain an SOC value which is high enough to be used in a forward driving segment.

FIG. 4A is a battery SOC correction process when a first forward driving segment and a second forward driving segment are a long uphill and a battery SOC value is expected to be discharged. First, to obtain a required battery charge output value of a current driving segment, an expected battery charge output value of each segment may be calculated when the first forward driving segment and the second forward driving segment are a long uphill. The expected battery charge output value of each forward driving segment may be an expected gradient driving output value during regenerative braking. The required battery charge output value of the current segment may be obtained by dividing the expected battery charge output value of each forward driving segment by an expected driving time of the current driving segment.

For example, as shown in FIG. 4A, the at least two or more driving segments are divided into a current driving segment Seg 0 and a forward driving segment. The forward driving segment is divided again into a first forward driving segment Seg 1 and a second forward driving segment Seg 2. In the current driving segment Seg 0, an expected amount of battery SOC change may be calculated for the first forward driving segment Seg 1 and the second forward driving segment Seg 2 of the vehicle and charging of the battery may be performed in advance. Herein, an amount of battery SOC change may not be controlled to maintain but may have a value below a preset reference point, and thus discharge may occur. Specifically, in an example, the first forward driving segment Seg 1 is a long slight uphill, on which a battery SOC value is slightly discharged at the preset reference point, and the second forward driving segment Seg 2 is a long steep uphill, on which the battery SOC value may be more drastically discharged at the preset reference point than in the first forward driving segment Seg 1.

On the other hand, in the case of a battery SOC correction device that performs fuel cell power control, since charging may be performed in a current driving segment as much as an amount of battery SOC change, even driving on a long uphill may not cause a battery SOC value to be lowered below a preset reference value. Specifically, in one embodiment, the first forward driving segment Seg 1 is a long slight uphill on which, as compared with the second forward driving segment Seg 2, and both the existing control and the fuel cell power generation control may have a slight amount of battery SOC value change. On the other hand, the second forward driving segment Seg 2 is a long steep uphill, on which an amount of battery SOC change may also be relatively drastic.

FIG. 4B shows a battery SOC correction process, according to an embodiment, when a first forward driving segment and a second forward driving segment are a long downhill and a battery SOC value is expected to be charged. In order to obtain a required battery charge output value of a current driving segment, an expected battery discharge output value of each segment may be calculated when the first forward driving segment and the second forward driving segment are a long downhill. The expected battery discharge output value of each segment may be calculated by subtracting an expected fuel cell power generation value from an expected gradient driving output value, when a vehicle is being driven. The required battery charge output value of the current segment may be obtained by dividing the expected battery discharge output value of each segment by an expected driving time of the current segment.

According to an embodiment, as shown in FIG. 4B, a driving segment is divided into a current driving segment Seg 0 and a forward driving segment. The forward driving segment is divided again into a first forward driving segment Seg 1 and a second forward driving segment Seg 2. In the current driving segment Seg 0, an expected amount of battery SOC change may be calculated for the first forward driving segment Seg 1 and the second forward driving segment Seg 2 of a vehicle, and discharge may be performed in advance. Herein, an amount of battery SOC change may not be controlled to maintain but to have a value exceeding a preset reference point, and thus overcharge may occur. Specifically, the first forward driving segment Seg 1 is a long slight downhill, on which a battery SOC value is slightly charged at the preset reference point, and the second forward driving segment Seg 2 is a long steep downhill, on which the battery SOC value may be more drastically charged at the preset reference point than in the first forward driving segment Seg 1.

On the other hand, according to an embodiment, in the case of a battery SOC correction device that performs fuel cell power control, since discharge may be performed in a current driving segment as much as an amount of battery SOC change, even driving on a long downhill may not cause a battery SOC value to exceed a preset reference value. Specifically, the first forward driving segment Seg 1 is a long slight downhill on which, as compared with the second forward driving segment Seg 2, both the existing control and the fuel cell power generation control may have a slight amount of battery SOC value change. On the other hand, the second forward driving segment Seg 2 is a long steep uphill, on which an amount of battery SOC change may also be relatively drastic.

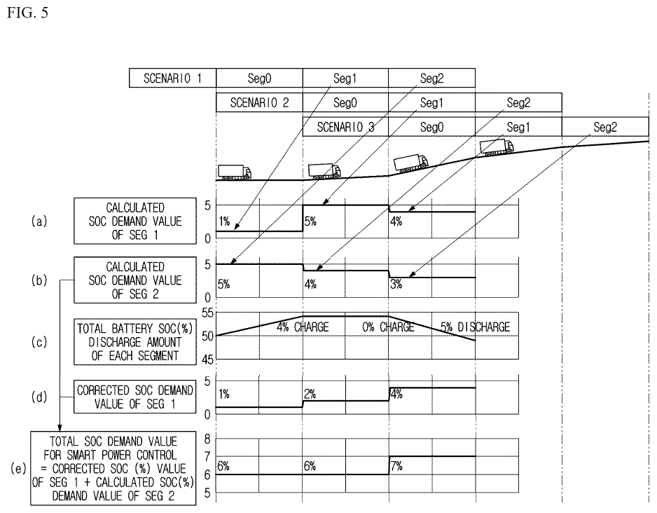

FIG. 5 is a graph showing an estimation result of change in a corrected battery SOC demand value based on each forward driving segment having continuous gradients via a battery SOC correction device of a vehicle. In particular, FIG. 5 depicts a process of obtaining a total battery SOC demand value for smart power control in various scenarios of continuous gradients through a battery SOC correction device of a vehicle according to the present disclosure.

First, for convenience of explanation, scenarios 1, 2, and 3 refer to a vehicle that is being driven on segments of a roadway in front of the vehicle successively over time. Seg 0 may mean a current driving segment in every scenario, Seg 1 may mean a first forward driving segment in every scenario, and Seg 2 may mean a second forward driving segment in every scenario. For example, the first forward driving segment Seg 1 in scenario 1 may correspond to the current driving segment Seg 0 of scenario 2, and the second forward driving segment Seg 2 of scenario 1 may correspond to the first forward driving segment Seg 1 of scenario 2.

In FIG. 5, (a) is a graph in which a battery SOC demand value of a segment corresponding to the first forward driving segment Seg 1 of each scenario is calculated. (b) is a graph in which a battery SOC demand value of a segment corresponding to the second forward driving segment Seg 2 of each scenario is calculated. (c) is a graph representing battery charge/discharge SOC demand values for all the driving segments of the vehicle. In addition, (d) is a graph representing a corrected battery SOC demand value of the first forward driving segment, which is required for smart power control. (e) is a graph representing a total battery SOC demand value required for smart power control. The graph shows a final total sum of battery charge/discharge SOC demand values for smart power control, which is obtained by adding a corrected battery SOC demand value of the first forward driving segment and a corrected battery SOC demand value of the second forward driving segment.

For example, a correction process is described below in which battery SOC demand values are compared between each segment when both the first forward driving segment and the second forward driving segment are a long uphill, i.e., form a continuous uphill.

For example, scenario 1 is a case in which both the first forward driving segment Seg 1 and the second forward driving segment Seg 2, which are received from a peripheral device of the vehicle, are long uphills, and battery SOC demand values required from each of the segments are expected to be 1% and 5% respectively. When scenario 2 completely drives on a current driving segment Seg 0 corresponding to the first forward driving segment Seg 1 of scenario 1, a battery SOC value of 4%, which is secured at the entry into the current driving segment, may be charged as a battery charge SOC demand value calculated according to a smart power control device.

In this case, as the SOC demand value (5%) of the first forward driving segment Seg 1 of scenario 1 is greater than the battery SOC value (4%) secured at the entry into the current driving segment of scenario 2, a corrected battery SOC demand value for the first forward driving segment Seg 1 of scenario 1 may be determined as an uncorrected value of 1%. Accordingly, the battery SOC demand value of 1% required for the current driving segment Seg 0 of scenario 2 may be secured, and for the expected battery SOC demand value of 5% for the first forward driving segment Seg 1 of scenario 1, 3% may also be secured. In addition, a total sum of battery SOC demand values, which is required for smart power control, may be calculated to be 6% by adding the corrected battery SOC demand value of 1% in the first forward driving segment Seg 1 of scenario 1 and the battery SOC demand value of 5% in the second forward driving segment Seg 2 of scenario 1.

Specifically, in the case of scenario 2, the battery SOC value secured at the entry into the current driving segment Seg 0 is 4%, the battery SOC demand value in the immediate previous first forward driving segment is 1%, and thus a corrected battery SOC demand value may be calculated by subtracting a pre-secured battery margin from the expected battery SOC value of the first forward driving segment Seg 1 of scenario 2. Accordingly, for the corrected battery SOC demand value, the pre-secured battery SOC margin at the entry into the current driving segment Seg 0 of scenario 2 may be subtracted from the battery SOC demand value of 5% in the first forward driving segment Seg 1 of scenario 2. The battery SOC margin may be calculated to be 3%, which is obtained by subtracting the battery SOC demand value of 1% in the immediate previous first forward driving segment, that is the first forward driving segment Seg 1 of scenario 1, from the battery SOC value of 4% secured at the entry into the current driving segment Seg 0 of scenario 2. Accordingly, the corrected battery SOC demand value may be determined as 2%. A total sum of battery SOC demand values for smart power control may be maintained to be 6% by adding the battery SOC demand value of 4% in the second forward driving segment Seg 2 of scenario 2 and the battery SOC demand value of 2% in the first forward driving segment Seg 1 of scenario 2.

On the other hand, if the expected battery SOC demand value, which is already secured at the entry into the current driving segment Seg 0 of scenario 2, is not corrected but the expected battery SOC demand value of the new first forward driving segment Seg 1 of scenario 2 is reflected as it is, there may be an error that a total expected battery SOC demand value keeps increasing. In other words, as the battery SOC value of 3% is already secured in scenario 1 corresponding to the previous driving segment of scenario 2, if the expected battery SOC demand value of 5% in the first forward driving segment Seg 1 of scenario 2 is all reflected, there may be an error that an ultimate battery SOC demand value increases.

Thus, when the expected battery SOC demand value of the first forward driving segment Seg 1 is all secured in scenario 1 that is an immediate previous segment and the expected battery SOC demand value of the second forward driving segment Seg 2 is already secured, an excessive error needs to be prevented by a process of correcting an expected battery SOC demand value in the first forward driving segment Seg 1 of scenario 3.

When the vehicle is driven to enter scenario 3 that has a first forward driving segment and a second forward driving segment as continuous uphills, expected battery SOC demand values may be calculated to be 4% and 3% for the new first forward driving segment Seg 1 of scenario 3, which corresponds to the second forward driving segment Seg 2 of scenario 2, and the second forward driving segment Seg 2, respectively.

When the vehicle is completely driven on the current driving segment Seg 0 of scenario 2, if 0% charge of battery SOC value is assumed, the expected battery SOC demand value of 5%, which is required for the current driving segment Seg 0 of scenario 3, may not be secured. In this case, it may be necessary to charge all the expected battery SOC demand value of the first forward driving segment Seg 1 of scenario 3. Accordingly, in order to prevent an error in the battery SOC value, if the expected battery SOC demand value of the first forward driving segment Seg 1 has not been secured in scenario 2, scenario 3 may also reflect the expected battery SOC demand value of the second forward driving segment Seg 2 of scenario 2, i.e., the first forward driving segment Seg 1 of scenario 3.

Specifically, a battery SOC value, which is secured at the entry into the current driving segment Seg 0 of scenario 3, is 4%, and a battery SOC value, which is secured in the immediate previous first forward segment, is 5%. In this case, as the battery SOC demand value of the immediate previous first forward segment is greater than the battery SOC value that is secured at the entry into the current driving segment Seg 0 of scenario 3, an uncorrected value, that is, the battery SOC demand value of 4% in the current driving segment Seg 0 of scenario 3 may be determined as a corrected value. A total sum of battery SOC demand values for smart power control may be calculated to be 7% by adding the battery SOC demand value of 3% in the second forward driving segment Seg 2 of scenario 3 and the battery SOC demand value of 4% in the first forward driving segment Seg 1 of scenario 3.

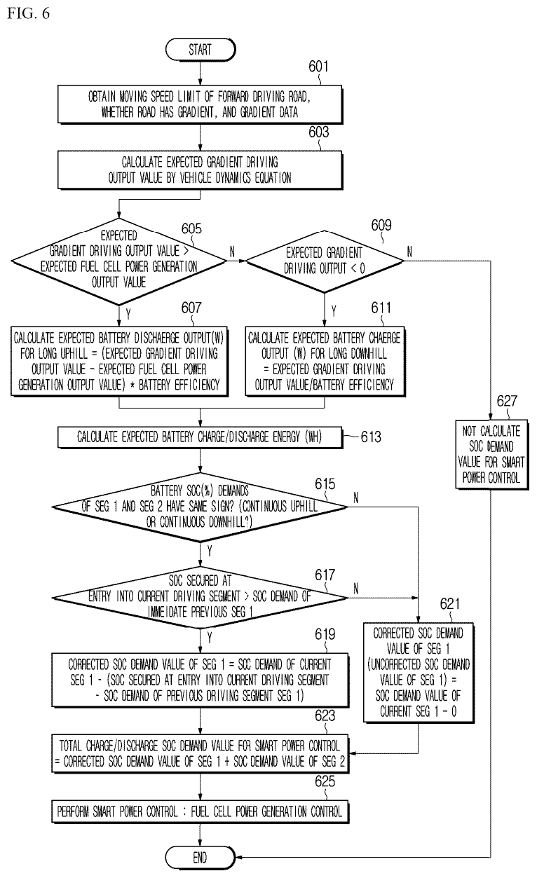

FIG. 6 is a view depicting a flowchart of an operating mechanism of a battery SOC correction device according to another embodiment of the present disclosure.

Referring to FIG. 6, a specific battery SOC correction method according to the present disclosure may determine whether a roadway ahead of a vehicle has a continuous gradient and calculate a corrected battery SOC demand value by comparing a battery SOC demand value, which is secured at the entry into an immediate previous driving segment, and an expected battery SOC demand value in a forward driving segment according to whether the roadway includes continuous uphills or downhills.

A process of operating a battery SOC correction device may be described with reference to FIG. 6 as follows. First, the battery SOC correction device may be initiated by receiving, as inputs, from a peripheral device (or devices) of the vehicle, information on whether two or more segments to be driven in the future have a gradient, a driving distance of each segment, and a speed limit of a vehicle and receiving, from a vehicle acceleration sensor and a drive torque sensor, a weight of the vehicle (601).

Next, based on the vehicle dynamics equation mentioned in Equation 1 above, an expected gradient driving output value of the two or more segments may be calculated (603). Herein, the expected gradient driving output value may be an expected required battery output value.

After the above process, the expected gradient driving output value and an expected fuel cell power generation output value are compared (605). When the expected gradient driving output value is larger than a threshold value, it may be determined that a forward driving segment is a long uphill, and an expected battery discharge output value may be calculated (607). Herein, the expected battery discharge output value may be calculated by multiplying a battery efficiency value and a value obtained by subtracting the expected fuel cell power generation output value from the expected gradient driving output value.

On the other hand, at step 605 above, when the expected gradient driving output value is smaller than the expected fuel cell power generation output value, it is determined whether the expected gradient driving output value is a negative number (609). If the value is a negative number, it may be determined that the forward driving segment is a long downhill, and an expected battery charge output value may be calculated (611). Herein, the expected battery charge output value may be a value obtained by dividing the expected gradient driving output value by a battery efficiency value. At step 609 above, if the expected gradient driving output value is smaller than the expected fuel cell power generation output value, a smart power control process for fuel cell power generation control may not be performed but may be terminated (627).

Next, total expected battery charge/discharge SOC demand values in a first forward driving segment Seg 1 and in a second forward driving segment Seg 2 may be calculated based on the expected battery charge/discharge output values obtained at steps 607 and 611 and then be converted into battery SOC demand values (613).

The total expected battery charge/discharge SOC demand values of the forward driving segments may be calculated by multiplying the expected battery charge/discharge output values and an expected driving time of the vehicle in the forward driving segments. The total expected battery charge/discharge SOC demand values of the forward driving segments may be divided by a total battery energy amount and thus be converted into battery SOC demand values.

Next, it may be determined whether the converted battery SOC demand values for the two or more forward driving segments have a same sign (615). Depending on whether they have a same sign, it may be determined that the forward driving segments are continuous uphills or continuous downhills. If the battery SOC demand values have different signs, a corrected battery SOC demand value of the first forward driving segment may be determined as an uncorrected value (621).

On the other hand, if the battery SOC demand values of the two or more forward driving segments have a same sign, a battery SOC value secured at the entry into a current driving segment and a battery SOC demand value of the first forward driving segment immediately prior to the entry into the current driving segment may be compared (617).

First, if the battery SOC value secured at the entry into the current driving segment is greater, the corrected battery SOC demand value of the first forward driving segment may be determined by subtracting a pre-secured battery SOC margin value from the battery SOC demand value of the first forward driving segment immediately prior to the current driving segment (619). Herein, the pre-secured battery SOC margin value may be a value that is obtained by subtracting the battery SOC demand value of the immediate previous first forward driving segment from the battery SOC value secured at the entry into the current driving segment.

On the other hand, if the battery SOC demand value in the first forward driving segment immediately prior to the entry into the current driving segment is greater than the battery SOC value secured at the entry into the current driving segment, the corrected battery SOC demand value of the first forward driving segment may be determined as an uncorrected value (621).

A final total sum of battery charge/discharge SOC demand values for smart power control may be obtained by adding the corrected battery SOC demand value of the first forward driving segment and the corrected battery SOC demand value of the second forward driving segment, which are calculated through steps 619 and 621 (623).

For the determined battery charge/discharge SOC demand value at step S623, it is possible to perform smart power control to secure an expected battery SOC value necessary for a forward driving segment in advance (625).

In other words, when roadway information is obtained for each segment of two or more segments of a roadway ahead of the vehicle, if the present disclosure is applied, an expected battery SOC demand value may be calculated based on whether a first forward driving segment of a road and a second forward driving segment of a road are a long uphill or a long downhill, and the expected battery SOC demand value may be converted into a required battery charge/discharge output value in a current driving segment. Thus, a fuel cell power generation output may be controlled, and a battery SOC demand value herein may be sufficiently secured or obtained for the vehicle to be driven via each segment of the roadway to reach a destination. In addition, when a battery SOC demand value and a corrected value are calculated for each forward driving segment by determining whether two or more forward driving segments have continuous gradients, it is expected that a battery SOC demand value may be predicted without accumulating errors.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various embodiments of the present disclosure do not disclose a list of all possible combinations and are intended to describe representative aspects of the present disclosure. Aspects or features described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, and the like.

The scope of the disclosure includes software or machine-executable commands (e.g., an operating system, an application, firmware, a program, etc.) for enabling operations according to various methods of various embodiments to be executed on an apparatus or a computer. Further, a non-transitory computer-readable medium includes such software or commands stored thereon which are executable on the apparatus or the computer.

What is claimed is:

1. A method for correcting a battery state of charge (SOC) of a vehicle, the method comprising:
dividing a roadway segment of a roadway in front of the vehicle into at least two or more segments;
obtaining roadway information for each segment of the at least two or more segments of the roadway;
determining an expected battery SOC demand value of each segment based on the obtained roadway information; and
determining whether to correct the expected battery SOC demand value of each segment based on whether the at least two or more segments have continuous gradients, and based thereon, performing a correction of the expected battery SOC demand value.

2. The method of claim 1, wherein the at least two or more segments of the roadway include a current driving segment and a forward driving segment, and wherein determining the expected battery SOC demand value includes:
dividing the forward driving segment into a first forward driving segment and a second forward driving segment; and
calculating the expected battery SOC demand value of the first forward driving segment and the second forward driving segment.

3. The method of claim 2, further comprising:
determining the expected SOC demand value by multiplying an expected battery charge/discharge output value and an expected future driving time; and
determining a required battery SOC demand value by dividing the expected battery SOC demand value by a total battery energy value.

4. The method of claim 3, further comprising:
determining whether the first forward driving segment and the second forward driving segment have continuous gradients based on whether the required battery SOC demand value of the first forward driving segment and the second forward driving segment has a same sign.

5. The method of claim 4, further comprising:
comparing, based on the first forward driving segment and the second forward driving segment having continuous gradients, at entry into the first forward driving segment, a battery SOC demand value secured in an immediate previous driving segment with the expected battery SOC demand value of the first forward driving segment.

6. The method of claim 5, further comprising:
determining, based on a battery SOC demand value secured at entry into the current driving segment being greater than the expected battery SOC demand value of the immediate previous driving segment, a corrected battery SOC demand value by subtracting a battery margin secured in the immediate previous driving segment from the battery SOC demand value of the first forward driving segment.

7. The method of claim 6, further comprising:
determining a total battery charge/discharge SOC value for fuel cell power generation control by adding the expected battery SOC demand value of the first forward driving segment and the expected battery SOC demand value of the second forward driving segment.

8. The method of claim 2, further comprising:
determining, based on the first forward driving segment and the second forward driving segment being long uphills, that the expected battery SOC demand value is an expected battery discharge output value; and
calculating the expected battery discharge output value by multiplying a battery efficiency value and a value obtained by subtracting an expected fuel cell power generation value from an expected gradient driving output value during driving.

9. The method of claim 2, further comprising:
determining, based on the first forward driving segment and the second forward driving segment being long downhills, that the expected battery SOC demand value is an expected battery charge output value; and
obtaining the expected battery charge output value by dividing an expected gradient driving output value by a battery efficiency value.

10. The method of claim 4, further comprising:
preventing, based on the first forward driving segment and the second forward driving segment having no continuous gradients, performing the correction of the expected battery SOC demand value.

11. A device for correcting a battery state of charge (SOC) of a vehicle by controlling a battery SOC demand value based on roadway information, the device comprising:
a memory configured to store at least one instruction;
a processor configured to execute the at least one instruction stored in the memory, and configured to divide a roadway segment of a roadway in front of the vehicle into at least two or more segments; and
a peripheral device configured to obtain roadway information for each segment of the at least two or more segments,
wherein the processor is further configured to:
determine an expected battery SOC demand value based on the roadway information of each segment that is input from the peripheral device; and
determine whether to correct the expected battery SOC demand value of each segment, based on whether the at least two or more segments have continuous gradients, and based thereon, perform a correction of the expected battery SOC demand value.

12. The device of claim 11, wherein the at least two or more segments include a current driving segment and a forward driving segment, and wherein the processor, to determine the expected battery SOC demand value, is further configured to:
divide the forward driving segment into a first forward driving segment and a second forward driving segment; and
calculate the expected battery SOC demand value of the first forward driving segment and the second forward driving segment based on the obtained roadway information.

13. The device of claim 12, wherein the processor is further configured to:
determine the expected SOC demand value by multiplying an expected battery charge/discharge output value and an expected future driving time; and
determine a required battery SOC demand value by dividing the expected battery SOC demand value by a total battery energy value.

14. The device of claim 13, wherein the processor is further configured to determine whether the first forward driving segment and the second forward driving segment have continuous gradients based on whether the required battery SOC demand value of the first forward driving segment and the second forward driving segment has a same sign.

15. The device of claim 14, wherein the processor is further configured to compare, based on the first forward driving segment and the second forward driving segment having continuous gradients, at entry into the first forward driving segment, a battery SOC demand value secured in an immediate previous driving segment with the expected battery SOC demand value of the first forward driving segment.

16. The device of claim 15, wherein the processor is further configured to determine, based on the battery SOC demand value secured at entry into the current driving segment being greater than the expected battery SOC demand value of the immediate previous driving segment, a corrected battery SOC demand value by subtracting a battery margin secured in the immediate previous driving segment from a battery SOC demand value of the first forward driving segment.

17. The device of claim 16, wherein the processor is further configured to determine a total battery charge/discharge SOC value for fuel cell power generation control by adding the expected battery SOC demand value of the first forward driving segment and the expected battery SOC demand value of the second forward driving segment.

18. The device of claim 12, wherein the processor is further configured to:
determine, based on the first forward driving segment and the second forward driving segment being long uphills, that the expected battery SOC demand value is an expected battery discharge output value; and
calculate the expected battery discharge output value by multiplying a battery efficiency value and a value obtained by subtracting an expected fuel cell power generation value from an expected gradient driving output value during driving.

19. The device of claim 12, wherein the processor is further configured to:
determine, based on the first forward driving segment and the second forward driving segment being long downhills, that the expected battery SOC demand value is an expected battery charge output value; and
obtain the expected battery charge output value by dividing an expected gradient driving output value by a battery efficiency value.

20. The device of claim 14, wherein the processor is further configured to prevent, based on the first forward driving segment and the second forward driving segment having no continuous gradients, performance of the correction of the expected battery SOC demand value.
